(19) United States
(12) Patent Application Publication
(10) Pub. No.: US 2024/0334326 A1
(43) Pub. Date: Oct. 3, 2024

(54) SYSTEMS AND METHODS OF UPDATING TARGET WAKE TIME SCHEDULES IN WIRELESS LANS

(71) Applicant: Meta Platforms Technologies, LLC, Menlo Park, CA (US)

(72) Inventors: Guoqing Li, Cupertino, CA (US); Sumeet Kumar Lnu, San Jose, CA (US); Rahul Srivastava, Santa Clara, CA (US); Neelakantan Nurani Krishnan, San Jose, CA (US)

(73) Assignee: Meta Platforms Technologies, LLC, Menlo Park, CA (US)

(21) Appl. No.: 18/586,956

(22) Filed: Feb. 26, 2024

Related U.S. Application Data
(60) Provisional application No. 63/456,211, filed on Mar. 31, 2023.

(51) Int. Cl. H04W 52/02

(52) U.S. Cl. CPC H04W 52/0216; H04W 52/0206

(57) ABSTRACT

A first device may include one or more processors. The one or more processors may be configured to generate, after establishing a target wake time (TWT) schedule having one or more TWT parameters with a second device, a first frame requesting the second device in a wireless local area network (WLAN) to update the one or more TWT parameters of the TWT schedule. The one or more processors may be configured to wirelessly transmit, via a transceiver, the generated first frame to the second device. The one or more processors may be configured to wirelessly receive, via the transceiver from the second device, a second frame indicating whether the one or more TWT parameters have been updated.

### CROSS-REFERENCE TO RELATED APPLICATION

This application claims priority to U.S. Provisional Patent Application No. 63/456,211, filed Mar. 31, 2023, which is incorporated by reference in its entirety for all purposes.

### FIELD OF DISCLOSURE

The present disclosure is generally related to managing target wake time (TWT) schedules in a wireless local area network (WLAN), including but not limited to systems and methods for dynamically updating TWT schedules in WLAN devices.

### BACKGROUND

Artificial reality such as virtual reality (VR), augmented reality (AR), or mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a system including one or more processors. In some embodiments, the one or more processors may be configured to generate, after establishing a target wake time (TWT) schedule having one or more TWT parameters with a second device, a first frame requesting the second device in a wireless local area network (WLAN) to update the one or more TWT parameters of the TWT schedule. The one or more processors may be configured to wirelessly transmit, via a transceiver, the generated first frame to the second device. The one or more processors may be configured to wirelessly receive, via the transceiver from the second device, a second frame indicating whether the one or more TWT parameters have been updated.

In some embodiments, one of the first device or the second device may be an access point. In some embodiments, the one or more TWT parameters may include at least one of a target wake time, a wake duration, or a wake interval.

In some embodiments, the one or more processors may be configured to set a first subfield of the first frame to an identifier identifying the TWT schedule. The one or more processors may be configured to set a second subfield of the first frame to a value indicating a request for updating the TWT schedule. The one or more processors may be configured to set one or more subfields of the first frame to a first set of one or more TWT parameters that are different from the one or more TWT parameters of the TWT schedule. The second frame may include a first subfield having the identifier identifying the TWT schedule, a second subfield having a value indicating a response to the request for updating the TWT schedule, and one or more subfields having a second set of one or more TWT parameters.

In some embodiments, the one or more processors may be configured to compare the first set of one or more TWT parameters with the second set of one or more TWT parameters. The one or more processors may be configured to determine, according to a result of the comparing, whether the one or more TWT parameters have been updated.

In some embodiments, the first frame may include a TWT information element (TWT IE). The TWT IE may include the first subfield, the second subfield and the one or more subfields of the first frame.

In some embodiments, the first frame may be a vendor specific action frame. The one or more processors may be configured to set a third subfield of the first frame to a value indicating a reason for updating the TWT schedule. The reason may include one of (1) a change in channel congestion, (2) a change in application traffic profile, or (3) an increase in queue depth. The vendor specific action frame may include a quality of service characteristics information element (QOS characteristics IE). Responsive to setting the third subfield to a value indicating (2) a change in application traffic profile, the one or more processors may be configured to set the QoS characteristics IE to one or more values indicating a new application traffic profile. The second frame may be a vendor specific action frame. The second frame may include a subfield having a value indicating a status of responding to the request for updating the TWT schedule. The status may be one of (1) request accepted, (2) request rejected with indication of alternative TWT parameters, or (3) request rejected without indication of alternative TWT parameters.

Various embodiments disclosed herein are related to a method including generating, by a first device after establishing a target wake time (TWT) schedule having one or more TWT parameters with a second device, a first frame requesting the second device in a wireless local area network (WLAN) to update the one or more TWT parameters of the TWT schedule. The method may include wirelessly transmitting, by the first device via a transceiver, the generated first frame to the second device. The method may include wirelessly receiving, by the first device via the transceiver from the second device, a second frame indicating whether the one or more TWT parameters have been updated.

In some embodiments, one of the first device or the second device may be an access point. In some embodiments, the one or more TWT parameters may include at least one of a target wake time, a wake duration, or a wake interval.

In some embodiments, a first subfield of the first frame may be set to an identifier identifying the TWT schedule. A second subfield of the first frame may be set to a value indicating a request for updating the TWT schedule. One or more subfields of the first frame may be set to a first set of one or more TWT parameters that are different from the one or more TWT parameters of the TWT schedule. The second frame may include a first subfield having the identifier identifying the TWT schedule, a second subfield having a value indicating a response to the request for updating the TWT schedule, and one or more subfields having a second set of one or more TWT parameters.

In some embodiments, the first set of one or more TWT parameters may be compared with the second set of one or more TWT parameters. According to a result of the comparing, it may be determined whether the one or more TWT parameters have been updated.

In some embodiments, the first frame may include a TWT information element (TWT IE). The TWT IE may include the first subfield, the second subfield and the one or more subfields of the first frame.

In some embodiments, the first frame may be a vendor specific action frame. A third subfield of the first frame may be to a value indicating a reason for updating the TWT schedule, wherein the reason includes one of (1) a change in channel congestion, (2) a change in application traffic profile, or (3) an increase in queue depth. The vendor specific action frame may include a quality of service characteristics information element (QOS characteristics IE). Responsive to setting the third subfield to a value indicating (2) a change in application traffic profile, the QoS characteristics IE may be set to one or more values indicating a new application traffic profile. The second frame may be a vendor specific action frame. The second frame may include a subfield having a value indicating a status of responding to the request for updating the TWT schedule. The status may be one of (1) request accepted, (2) request rejected with indication of alternative TWT parameters, or (3) request rejected without indication of alternative TWT parameters.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram of a power save mechanism and TWT operations, according to an example implementation of the present disclosure.

FIG. 5 is a flow diagram of a process to update a TWT schedule, according to an example implementation of the present disclosure.

FIG. 6 illustrates example field formats of a TWT information element (or TWT IE) for updating a TWT schedule, according to an example implementation of the present disclosure.

FIG. 7A and FIG. 7B illustrate example field formats of vendor specific action frames for updating a TWT schedule, according to an example implementation of the present disclosure.

FIG. 8A and FIG. 8B illustrate example field formats of a TWT parameter set field and a quality of service characteristic information element (or QoS Characteristic IE) for updating a TWT schedule, according to an example implementation of the present disclosure.

FIG. 9 is a flowchart showing a method for updating a TWT schedule, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

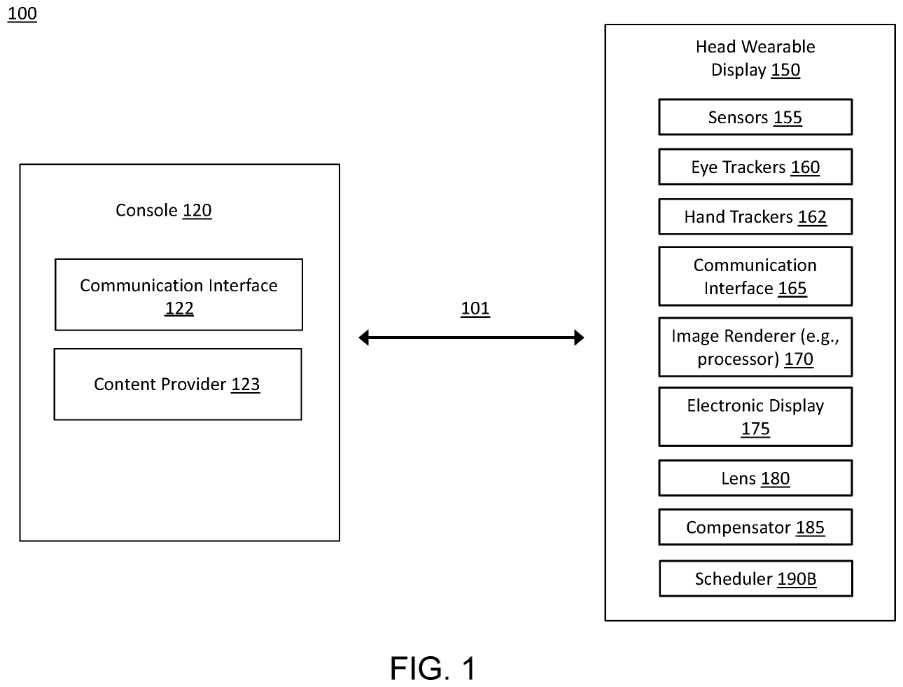

FIG. 1 is a block diagram of an example artificial reality system environment 100 in which a console 120 operates. FIG. 1 provides an example environment in which devices may communicate traffic streams with different latency sensitivities/requirements. In some embodiments, the artificial reality system environment 100 includes a HWD 150 worn by a user, and a console 120 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 120 through a wired or wireless connection. The HWD 150 may also identify objects (e.g., body, hand face).

The console 120 may determine a view within the space of the artificial reality corresponding to the detected location, orientation and/or the gaze direction, and generate an image depicting the determined view. The console 120 may also receive one or more user inputs and modify the image according to the user inputs. The console 120 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 120 may be performed by the HWD 150, and/or some of the functionality of the HWD 150 may be performed by the console 120.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 120, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 120 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is-10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 120. The communication interface 165 may communicate with a communication interface 122 of the console 120 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 120 and the head wearable display 150 are implemented on a single system, the communication interface 165 may communicate with the console 120 through a bus connection or a conductive trace. Through the communication link, the communication interface 165 may transmit to the console 120 sensor measurements indicating the determined location of the HWD 150, orientation of the HWD 150, the determined gaze direction of the user, and/or hand tracking measurements. Moreover, through the communication link, the communication interface 165 may receive from the console 120 sensor measurements indicating or corresponding to an image to be rendered.

Using the communication interface, the console 120 (or HWD 150) may coordinate operations on link 101 to reduce collisions or interferences. For example, the console 120 may coordinate communication between the console 120 and the HWD 150. In some implementations, the console 120 may transmit a beacon frame periodically to announce/advertise a presence of a wireless link between the console 120 and the HWD 150 (or between two HWDs). In an implementation, the HWD 150 may monitor for or receive the beacon frame from the console 120, and can schedule communication with the HWD 150 (e.g., using the information in the beacon frame, such as an offset value) to avoid collision or interference with communication between the console 120 and/or HWD 150 and other devices.

The console 120 and HWD 150 may communicate using link 101 (e.g., intralink). Data (e.g., a traffic stream) may flow in a direction on link 101. For example, the console 120 may communicate using a downlink (DL) communication to the HWD 150 and the HWD 150 may communicate using an uplink (UL) communication to the console 120.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 120 may be encoded, and the image renderer 170 may decode the data to generate and render the image. In one aspect, the image renderer 170 receives the encoded image from the console 120, and decodes the encoded image, such that a communication bandwidth between the console 120 and the HWD 150 can be reduced.

In some embodiments, the image renderer 170 receives, from the console 120, additional data including object information indicating virtual objects in the artificial reality space and depth information indicating depth (or distances from the HWD 150) of the virtual objects. Accordingly, the image renderer 170 may receive from the console 120 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 120, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 120 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 120 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 120 is an electronic component or a combination of an electronic component and a software component that provides content to be rendered to the HWD 150. In one aspect, the console 120 includes a communication interface 122 and a content provider 123. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 120 includes more, fewer, or different components than shown in FIG. 1. In some embodiments, the console 120 is integrated as part of the HWD 150. In some embodiments, the communication interface 122 is an electronic component or a combination of an electronic component and a software component that communicates with the HWD 150. The communication interface 122 may be a counterpart component to the communication interface 165 to communicate with a communication interface 122 of the console 120 through a communication link (e.g., USB cable, a wireless link). Through the communication link, the communication interface 122 may receive from the HWD 150 sensor measurements indicating the determined location and/or orientation of the HWD 150, the determined gaze direction of the user, and/or hand tracking measurements. Moreover, through the communication link, the communication interface 122 may transmit to the HWD 150 data describing an image to be rendered.

The content provider 123 can include or correspond to a component that generates content to be rendered according to the location and/or orientation of the HWD 150, the gaze direction of the user and/or hand tracking measurements. In one aspect, the content provider 123 determines a view of the artificial reality according to the location and orientation of the HWD 150 and/or the gaze direction of the user of the HWD 150. For example, the content provider 123 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 123 may generate image data describing an image of the determined view of the artificial reality space, and transmit the image data to the HWD 150 through the communication interface 122. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 123 generates metadata including motion vector information, depth information, edge information, object information, etc., associated with the image, and transmits the metadata with the image data to the HWD 150 through the communication interface 122. The content provider 123 may encode and/or encode the data describing the image, and can transmit the encoded and/or encoded data to the HWD 150. In some embodiments, the content provider 123 generates and provides the image to the HWD 150 periodically (e.g., every one second).

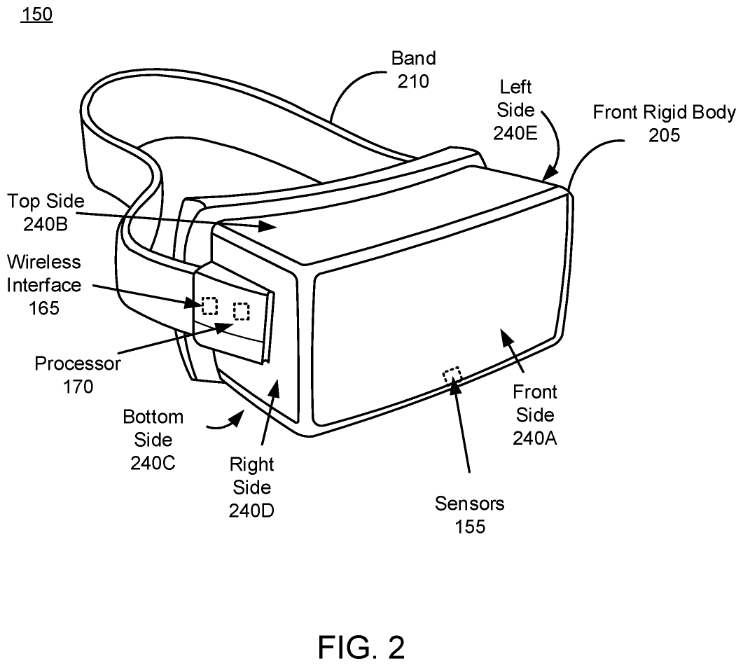

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

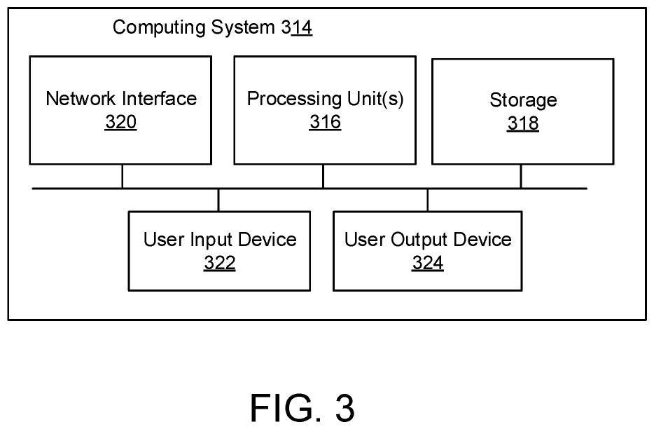

Various operations described herein can be implemented on computer systems. FIG. 3 shows a block diagram of a representative computing system 314 usable to implement the present disclosure. In some embodiments, the console 120, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

In one aspect, target wake time (TWT) is a feature introduced in wireless network standards (e.g., Wi-Fi 6, IEEE 802.11ax) to enable power-save in Wi-Fi devices (for example, access points (APs), software enabled access points (SoftAPs), non-AP STAs). TWT can allow a device to enter power save state according to a pre-determined sleep schedule (e.g., TWT schedule) without needing to notify the Wi-Fi AP about this transition. Such pre-determined sleep schedule can achieve lower power consumption and hence achieve improved battery life. TWT can establish a wake schedule (e.g., TWT schedule) between a pair of devices. The following two parameters can be negotiated between the devices: (1) wake duration—also known as service period (SP) duration, indicating the duration for which a device remains awake; and (2) TWT SP interval—an interval between successive TWT service periods. In some implementations, no data exchange between devices may occur outside the established schedule. TWT may be best suited for applications that are deterministically periodic, e.g., generation of payload at a known periodicity (e.g., x Mbps at y frames per second) such as live streaming, or remote rendering.

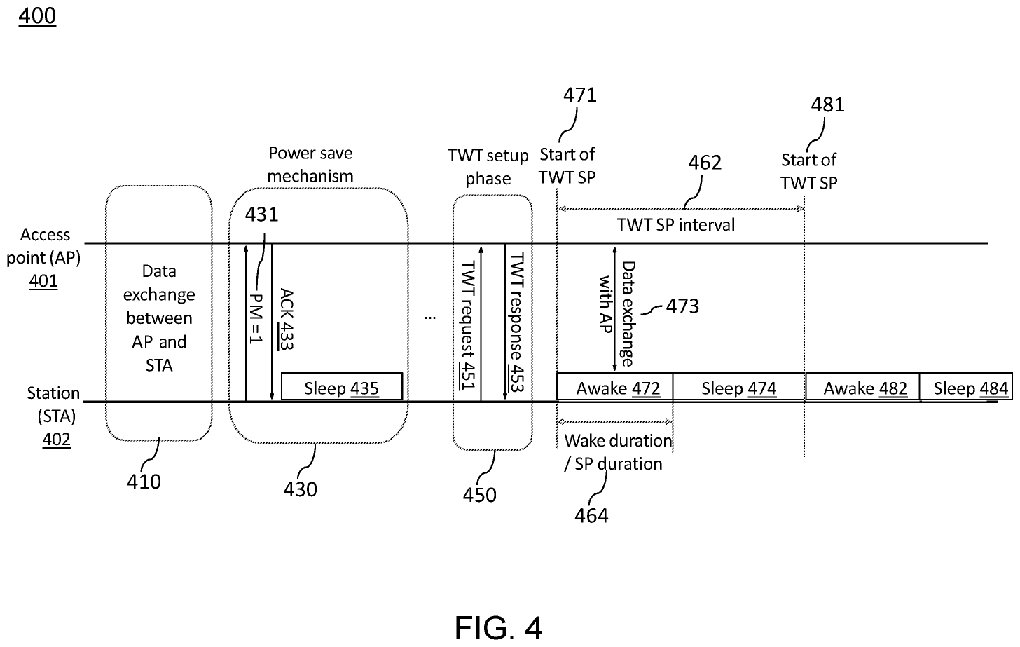

FIG. 4 is a timing diagram 400 of a power save mechanism and TWT operations, according to an example implementation of the present disclosure. Data exchange 410 can be performed between an access point (AP) 410 (e.g., Wi-Fi 6 capable AP) and a station (STA) 420 (e.g., Wi-Fi 6 capable STA). The STA 420 may enter a sleep mode/state 435 (e.g., power save mode) using a power save mechanism 430. For example, the STA 420 may send a data frame to the AP 410 with a power management bit (e.g., PM bit 431) set to 1, and the AP 410 may send an ACK frame 433 in response to the data frame. When using the power save mechanism, this exchange (e.g., exchange of a data frame with PM=1 and an ACK frame) may happen every time a STA desires to enter a sleep state, thereby incurring non-zero overhead. On the other hand, in the TWT mechanism, the AP 410 and the STA 420 can set up 450 a predetermined wake schedule, e.g., TWT schedule, including a TWT start time, a TWT SP interval (e.g., TWT SP interval 462) and a wake duration (e.g., wake duration or SP duration 464), by exchanging a TWT request frame 451 and a TWT response frame 453. Upon establishing the TWT schedule, the STA 420 may periodically wake up according to the TWT schedule. For example, the STA 420 may start a SP of the schedule having a predetermined wake duration 464 at predetermined start times (e.g., SP start times 471, 481) periodically with a predetermined TWT SP interval 462. The STA 420 can repeatedly alternate an awake/active mode (e.g., awake 472, 482 during an SP) during an SP and a sleep/power-save mode (e.g., sleep 474, 484). In this manner, the STA 420 can perform data exchange 473 with the AP 401 during each SP, and can enter a sleep/power-save mode without notifying the AP 401.

In one aspect, although TWT can alleviate data exchange overhead (e.g., data frame with PM=1 and ACK frame as shown in FIG. 4), because a TWT schedule is a pre-determined, it would be difficult to dynamically change/update/modify the pre-determined schedule. For example, some implementations can define a “flexible TWT” through which a TWT time (e.g., TWT start time) can be changed but the flexible TWT cannot change/update other TWT parameters (e.g., SP wake duration or SP interval). Some implementations can revamp an existing TWT schedule (e.g., on SP wake duration and SP interval) but only by tearing down the current TWT schedule and creating a new TWT schedule (e.g., break and make process). This break and make process may incur an overhead of frame exchanges (e.g., TWT teardown+TWT request+TWT response). Moreover, the current TWT may not be suited due to some dynamically changing situations (e.g., changes in channel congestion, application traffic profile, transmit queue depth). For example, changes in channel congestion may occur due to more devices in the network, and/or increased wireless activity from other co-channel devices. Changes in application traffic profile may occur if a use-case traffic profile of an application changes (e.g., from x Mbps at y frame per second (fps) to w Mbps at z fps). Changes in transmit queue depth (e.g., increasing queue depth) may occur when application packets start backing up in the transmit queue beyond tolerance. Therefore, it would be beneficial if a pre-existing TWT schedule between a pair of devices can be dynamically updated without tearing down the TWT schedule.

To address these problems, embodiments of the present disclosure provide mechanisms to dynamically update an existing TWT schedule (or an SP thereof) without tearing down the current agreement on the existing TWT schedule. In this manner, existing TWT schedules (or SP thereof) can be dynamically updated in response to changes in channel congestion, application profiles, or queue depth, for example.

In one approach, a system/method can dynamically update an existing TWT schedule established between two devices (e.g., AP and STA, or two STAs) by exchanging a TWT update request frame and a TWT update response frame. In some embodiments, a first device STA #1 (e.g., an AP or a non-AP STA) and a second device STA #2 (e.g., an AP or a non-AP STA) may establish an initial TWT schedule. In response to establishing the TWT schedule, each of STA #1 and STA #2 may monitor changes in (1) traffic between the two devices in a wireless channel and/or (2) applications (e.g., application running on STA #1). In monitoring changes, STA #2 may detect that a degree of a channel congestion metric is greater than a threshold. The channel congestion metric may include at least one of latency, packet loss, jitter, throughput, network device resource utilization, or channel (or co-channel) interference (which can be calculated/estimated based on noise level or power, signal strength such as received signal strength indicator (RSSI), signal to noise ratio (SNR)).

In response to detecting channel congestion, STA #2 may send a TWT update request frame including one or more desired TWT parameters (e.g., a TWT start time, a TWT SP (wake) interval, an SP (wake) duration), to STA #1. In response to the TWT update request frame, STA #1 may send a TWT update response frame to STA #2. In some embodiments, the TWT update response frame may indicate at least one of accepting the request, rejecting the request, or suggesting alternative TWT parameters different from the request. In some embodiments, the update response frame may include one or more TWT parameters which are equal to the TWT parameters included in the TWT update request, indicating acceptance of the request. The update response frame may include one or more TWT parameters which are different from the TWT parameters included in the TWT update request, indicating rejection of the request or suggestion of alternative TWT parameters. In some embodiments, the update response frame includes a field (or subfield) having a value indicating at least one of accepting the request, rejecting the request, or suggesting alternative TWT parameters different from the request. For example, if the TWT update response frame indicates that the request has been accepted, STA #1 and STA #2 can update the TWT schedule according to the one or more desired TWT parameters specified in the TWT update request frame.

In some embodiments, each of STA #1 and STA #2 may monitor changes in applications (e.g., application running thereon) or network queues (e.g., transmit queues or receive queues in applications or networking stacks or network interface). In monitoring changes, STA #1 may detect that a traffic profile, traffic pattern, or network queue (e.g., transmit queue) of one or more applications running on STA #1 has been changed. For example, STA #1 may detect that a use-case traffic profile of an application changes (e.g., from x Mbps at y frame per second (fps) to w Mbps at z fps); or that transmit queue depth changes (e.g., increasing queue depth) such that application packets start backing up in the transmit queue beyond tolerance. In response to detecting the change of traffic profile, traffic pattern, or network queue, STA #1 may send a TWT update request frame including one or more desired TWT parameters (e.g., a TWT start time, a TWT SP (wake) interval, an SP (wake) duration) better suited to the change, to STA #2. In response to the TWT update request frame, STA #2 may send a TWT update response frame to STA #1. In some embodiments, the TWT update response frame may indicate at least one of accepting the request, rejecting the request, or suggesting alternative TWT parameters different from the request. For example, if the TWT update response frame indicates that the request has been accepted, STA #1 and STA #2 can update the TWT schedule according to the one or more desired TWT parameters specified in the TWT update request frame to reflect the traffic profile change.

In one approach, a system/method can update an existing TWT schedule using a TWT information element (“TWT element” or “TWT IE”). In some embodiments, a TWT update request frame may include/use/reuse/repurpose the format of a TWT element to indicate a request for an update of an existing TWT schedule. In some embodiments, a TWT update response frame may include/use/reuse/repurpose the format of a TWT element to indicate a response to a request for an update of an existing TWT schedule.

In some embodiments, the format of a TWT element may include the fields of element ID, length, control, and/or TWT parameter information. The field of TWT parameter information may include the subfields of request type, target wake time, TWT group assignment, nominal minimum TWT wake duration, TWT wake interval mantissa, TWT channel, and/or Non-scheduled Delivery Paging (NDP) paging (optional). The request type subfield may include the subfields of TWT request, TWT setup command, trigger, implicit, flow type, TWT flow identifier, TWT wake interval exponent, and/or TWT protection.

The TWT request subfield may indicate whether the TWT element represents a request or response. In some embodiments, the size of the TWT request subfield may be two bits. For example, if the TWT request subfield has a value of 0 (“00” when the size of the TWT request subfield is two bits), then the TWT element may represent to initiate or request (from a TWT requesting STA) TWT negotiation/scheduling/setup for a new TWT schedule. If the TWT request subfield has a value of 1 (“01” when the size of the TWT request subfield is two bits), then the TWT element may represent/indicate to initiate or request (from a TWT update requesting STA) update of an existing TWT schedule. If the TWT request subfield has a value of 2 or 3 (“10” or “11” when the size of the TWT request subfield is two bits), then the TWT element may represent to respond (from a TWT update responding STA) to a TWT request (e.g., either a request for a new TWT schedule or a request for updating an existing TWT schedule). In some embodiments, if the TWT request subfield has a value of “10”, the TWT element may represent to respond to a request for a new TWT schedule, while if the TWT request subfield has a value of “11”, the TWT element may represent to respond to a request for updating an existing TWT schedule. The values of the TWT request subfield described above are mere examples and embodiments of the present disclosure are not limited thereto.

The TWT element may contain one or more TWT parameters for one or more TWT negotiations or update negotiations. For example, the one or more TWT parameters may include (1) a TWT start time specified in the target wake time subfield, (2) a TWT wake duration or SP duration specified in the subfield of nominal minimum TWT wake duration, and/or (3) a TWT wake interval specified in the subfields of TWT wake interval mantissa and/or TWT wake interval exponent. Each of the TWT (update) negotiations contained in the TWT element may be identified by a unique TWT flow identifier specified in the subfield of TWT flow identifier. For example, in case of TWT schedule update, the TWT flow identifier (ID) corresponding to the already existing TWT agreement may be used in the subfield of TWT flow identifier. In some embodiments, the subfield of TWT flow identifier may be set to a TWT flow ID corresponding to any TWT schedule (e.g., either the current TWT schedule or any other TWT schedule) so that a TWT schedule that is not the current TWT schedule can be updated.

During the process of updating an existing TWT schedule, a STA requesting a TWT STA update may generate a TWT update request frame including a TWT element. The requesting STA may set (1) one or more TWT parameters of the TWT element (e.g., the subfields of target wake time, nominal minimum TWT wake duration, TWT wake interval mantissa and/or TWT wake interval exponent) to values different from those of an existing TWT schedule to reflect a detected channel condition or a detected traffic profile change, (2) the TWT request subfield of the TWT element to a value (e.g., “01”) indicating a request for updating the existing TWT schedule, and/or (3) the TWT flow identifier subfield of the TWT element to a value corresponding to the TWT flow ID of an existing TWT schedule or agreement (e.g., either the current TWT schedule or any other TWT schedule).

During the process of updating the TWT schedule, a STA responding to the request for the TWT schedule update may generate/output/establish a TWT update response frame including a TWT element. The responding STA may set (1) one or more TWT parameters of the TWT element (e.g., the subfields of target wake time, nominal minimum TWT wake duration, TWT wake interval mantissa and/or TWT wake interval exponent) to values that are the same as, or different from, those specified in the TWT element of the TWT update request frame, (2) the TWT request subfield of the TWT element to a value (e.g., “10” or “11”) indicating a response to the request for updating the existing TWT schedule, and/or (3) the TWT flow identifier subfield of the TWT element to the value corresponding to the TWT flow ID of an existing TWT schedule or agreement (e.g., either the current TWT schedule or any other TWT schedule). If the one or more TWT parameters specified in the TWT update response frame are the same as those specified in the TWT update request frame, the STA responding to the request may confirm the update of TWT parameters to reflect the detected channel congestion or the detected traffic profile change. On the other hand, if the one or more TWT parameters specified in the TWT update response frame are different from those specified in the TWT update request frame, the STA responding to the request may reject the update of TWT parameters and/or may indicate or suggest, as alternative TWT parameters, the one or more TWT parameters specified in the TWT update response frame.

In one approach, a system/method can update an existing TWT schedule using vendor specific action frames (VSAFs). In some embodiments, a TWT update request frame may be a VSAF or include/use/reuse/repurpose/leverage the format of a VSAF, to indicate a request for an update of an existing TWT schedule. In some embodiments, a TWT update response frame may be a VSAF or include/use/reuse/repurpose/leverage the format of a VSAF, to indicate a response to a request for an update of an existing TWT schedule.

In some embodiments, the format of a VSAF as the TWT update request frame may include a medium access control (MAC) header, a category field, and vendor specific content. The MAC header may include the fields of frame control, duration, destination address, source address, basic service set ID (BSSID), and/or sequence control. The vendor specific content may include the fields of organization identifier (OUI), version, dialog token, element ID, length, request/response, reason/status code, TWT parameter set, QoS characteristic IE, and/or frame check sequence (FCS). The category field may have a value indicating a VSAF. For example, the category field may be set to “0x7E” which indicates a protected VSAF. The OUI field may be a public OUI assigned by the IEEE. The element ID field may have an ID value indicating a TWT update information element (TWT update IE). The length field may indicate a length of the TWT update IE. The TWT parameter set may indicate TWT parameters pertinent to an intended TWT schedule.

Similarly, the format of a VSAF as the TWT update response frame may include a MAC header, a category field, and vendor specific content. The MAC header may include the fields of frame control, duration, destination address, source address, BSSID, and/or sequence control. The vendor specific content may include the fields of OUI, version, dialog token, element ID, length, request/response, reason/status code, TWT parameter set, QoS characteristic IE, and/or FCS. The category field may have a value indicating a VSAF. For example, the category field may be set to “0x7E” which indicates a protected VSAF. The OUI field may be a public OUI assigned by the IEEE. The element ID field may have an ID value indicating the TWT update IE. The length field may indicate a length of the TWT update IE. The TWT parameter set may indicate TWT parameters pertinent to an alternative TWT schedule (e.g., when the request has been rejected).

The request/response field may indicate whether the VSAF represents a TWT update request frame or a TWT update response frame. In some embodiments, the size of the request/response field may be one bit. For example, if the request/response field has a value of 0, then the VSAF may represent to initiate or request (e.g., from a TWT update requesting STA) update of an existing TWT schedule. If the request/response field has a value of 1, then the VSAF may represent/indicate to respond (e.g., from a TWT update responding STA) to a TWT request (e.g., a request for updating an existing TWT schedule). The reason/status code field in a TWT update request frame may indicate one or more reasons for updating an existing TWT schedule. For example, the reason/status code field in the TWT update request frame may have one or more values selected from a plurality of values including 1 for channel congestion, 2 for application traffic profile change, 3 for increased queue depth, and 4-127 for reserved/unused values. The reason/status code field in a TWT update response frame may indicate one or more statuses for responding to the request for updating an existing TWT schedule. In some embodiments, the size of the reason/status code field may be at least one octet (or 8 bits). For example, the reason/status code field in the TWT update response frame may have one or more values selected from a plurality of values including for example 128 for request accepted, 129 for request rejected with suggestion of alternative TWT parameters, 130 for request rejected without suggestion of alternative TWT parameters, and 131-255 for reserved/unused values. The values of the fields of the VSAF described above are mere examples and embodiments of the present disclosure are not limited thereto.

In some embodiments, the TWT parameter set field may contain one or more TWT parameters (e.g., TWT start time, TWT wake duration, TWT wake interval) for one or more TWT negotiations or update negotiations. For example, the TWT parameter set field may include the subfields of TWT flow identifier, wake duration unit, target wake time, wake duration, TWT wake interval exponent, TWT wake interval mantissa, trigger, implicit, and/or flow type. Each of the TWT (update) negotiations contained in the VSAF may be identified by a unique TWT flow identifier specified in the subfield of TWT flow identifier. For example, in case of TWT schedule update, the TWT flow identifier (ID) corresponding to the already existing TWT agreement may be used in the subfield of TWT flow identifier. In some embodiments, the subfield of TWT flow identifier may be set to a TWT flow ID corresponding to any TWT schedule (e.g., either the current TWT schedule or any other TWT schedule) so that a TWT schedule that is not the current TWT schedule can be updated. The target wake time subfield may represent a TWT start time specified. The subfields of wake duration and wake duration unit (e.g., ms or μs) may represent/indicate a TWT wake duration or SP duration. The subfields of TWT wake interval exponent and TWT wake interval mantissa may represent/indicate a TWT wake interval.

In some embodiments, the QoS characteristic IE may include the subfields of element ID, length, element ID extension, control info, minimum service interval, maximum service interval, minimum data rate, delay bound, maximum MAC service data unit (MSDU) size, service start time, mean data rate, burst size, MSDU lifetime, MSDU delivery ratio, MSDU count exponent, and/or medium time. In some embodiments, a request VSAF may optionally include the QoS characteristic IE set to QoS characteristic values corresponding to a new traffic profile if the reason/status code is set to indicate a traffic profile change (e.g., value 2). In some embodiments, a response VSAF may optionally include the QoS characteristic IE.

In some embodiments, during the process of updating an existing TWT schedule, a STA requesting a TWT STA update may generate a TWT update request frame which may be or include a VSAF. The STA may set (1) the request/response subfield of the VSAF to a value (e.g., 0) indicating a request for updating the existing TWT schedule, (2) the reason/status code field of the VSAF to one or more values selected from a plurality of values indicating reasons for updating the existing TWT schedule (e.g., value 1 for channel congestion, value 2 for application traffic profile change, value 3 for increased queue depth), (3) the TWT parameter set field of the VSAF (e.g., wake duration unit, target wake time, wake duration, TWT wake interval exponent, TWT wake interval mantissa) to values different from one or more TWT parameters of the existing TWT schedule to reflect reasons specified in the reason/status code field, and/or (4) the TWT flow identifier subfield of the VSAF to a value corresponding to the TWT flow ID of the existing TWT schedule or agreement. In some embodiments, the subfield of TWT flow identifier may be set to a TWT flow ID corresponding to any TWT schedule (e.g., either the current TWT schedule or TWT schedule) so that a TWT schedule that is not the current TWT schedule can be updated.

In some embodiments, during the process of updating the TWT schedule, a STA responding to the request for the TWT schedule update may generate a TWT update response frame which may be or include a VSAF. The STA may set (1) the request/response subfield of the VSAF to a value (e.g., 1) indicating a response to a request for updating the existing TWT schedule, (2) the reason/status code field of the VSAF to one or more values selected from a plurality of values indicating statuses in response to the request (e.g., request accepted, request rejected with suggestion of alternative TWT parameters, request rejected without suggestion of alternative TWT parameters), (3) the TWT parameter set field of the VSAF (e.g., wake duration unit, target wake time, wake duration, TWT wake interval exponent, TWT wake interval mantissa) to values corresponding to alternative TWT parameters (e.g., if the reasons/status code field is set to “request rejected with suggestion of alternative TWT parameters”), and/or (4) the TWT flow identifier subfield of the VSAF to a value corresponding to the TWT flow ID of the existing TWT schedule or agreement. In some embodiments, the subfield of TWT flow identifier may be set to a TWT flow ID corresponding to any TWT schedule (e.g., either the current TWT schedule or TWT schedule) so that a TWT schedule that is not the current TWT schedule can be updated.

In some embodiments, during the process of updating an existing TWT schedule between STA #1 (e.g., an AP or a non-AP STA) and STA #2 (e.g., an AP or a non-AP STA), a requesting STA (e.g., STA #1) may issue/send a TWT update request frame which is or includes a VSAF, to a recipient STA (e.g., STA #2) informing STA #2 about not only one or more requested TWT parameters but also a need/intent/reason/motivation to update the existing TWT schedule. The request VSAF may include the reason/status code subfield to indicate the need/intent/reason/motivation to change the existing TWT schedule and may include the TWT parameter set field set to a preferred TWT schedule as well. STA #2 may receive the request VSAF and assess/evaluate/determine whether a change is warranted. Based on the evaluation, STA #2 may respond back with a response VSAF to STA #1 indicating whether the change has been accepted, rejected, or rejected with a proposed alternative change.

For example, during the process of updating an existing TWT schedule, after STA #1 and STA #2 establish an initial TWT schedule, STA #1 may receive a TWT update request frame from STA #2. The TWT update request frame may be a VSAF having the above-described format. The request VSAF frame may include (1) the request/response field set to indicate a “request” (e.g., value 0), (2) the reason/status code field set to indicate channel congestion (e.g., value 0x1), and (3) the TWT parameter set field set to TWT parameters of a new TWT schedule to reflect the channel congestion. In response to the TWT update request frame, STA #1 may send a TWT update response frame to STA #2. The TWT update response frame may be a VSAF having the above-described format. The response VSAF frame may include (1) the request/response field set to indicate a “response” (e.g., value 1), (2) the reason/status code field set to an appropriate status code (e.g., value 128 to indicate the request has been accepted, value 129 to indicate the request has been rejected with suggestion of alternative TWT parameters, or value 130 to indicate the request has been rejected without suggestion), and/or (3) the TWT parameter set field set to alternative/proposed TWT parameters (e.g., when the reason/status code field set to value 129 to indicate the request has been rejected with suggestion of alternative TWT parameters).

As a result of monitoring channel congestion or application traffic profile patterns, STA #1 may send a TWT update request frame to STA #2. The TWT update request frame may be a VSAF having the above-described format. The request VSAF frame may include (1) the request/response field set to indicate a “request” (e.g., value 0), (2) the reason/status code field set to indicate a traffic profile change (e.g., value 0x2), (3) the TWT parameter set field set to TWT parameters of a new TWT schedule to reflect the traffic profile change, and/or (4) the QoS characteristic IE set to QoS characteristic values corresponding to a new traffic profile (due to the traffic profile change). In response to the TWT update request frame, STA #2 may send a TWT update response frame which may be a VSAF having the above-described format. The response VSAF frame may include (1) the request/response field set to indicate a “response” (e.g., value 1), (2) the reason/status code field set to an appropriate status code (e.g., “the request accepted”, “the request rejected with suggestion of alternative TWT parameters”, or “the request rejected without suggestion), and/or (3) the TWT parameter set field set to alternative/proposed TWT parameters (e.g., when the reason/status code field set to value 129 to indicate the request has been rejected with suggestion of alternative TWT parameters).

Embodiments in the present disclosure have at least the following advantages and benefits.

First, embodiments in the present disclosure can provide useful techniques for updating a pre-existing TWT schedule between a pair of devices without tearing down the pre-existing TWT schedule or creating a new TWT schedule (e.g., break and make process). In this manner, the TWT schedule can be dynamically updated without incurring an overhead of frame exchanges (e.g., TWT teardown+TWT request+TWT response).

Second, embodiments in the present disclosure can provide useful techniques for dynamically updating existing TWT schedules (or SP thereof) in response to changes in channel congestion, application profiles, or queue depth. These dynamic update techniques would be beneficial to cope with the following situations: (1) changes in channel congestion due to more devices in the network, and/or increased wireless activity from other co-channel devices; (2) changes in application traffic profile if a use-case traffic profile of an application changes (e.g., from x Mbps at y fps to w Mbps at z fps); and/or (3) changes in transmit queue depth (e.g., increasing queue depth) when application packets start backing up in the transmit queue beyond tolerance.

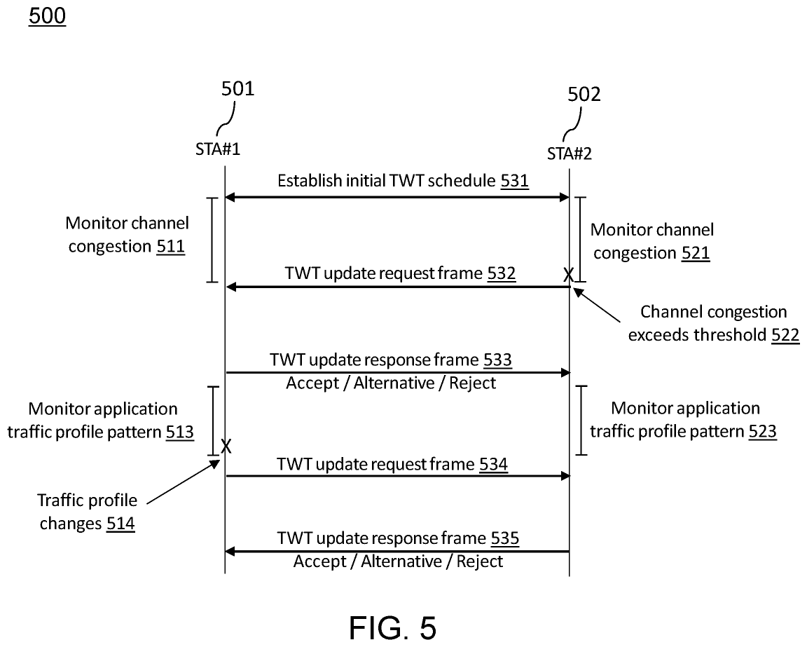

FIG. 5 is a flow diagram of a TWT schedule update process 500, according to an example implementation of the present disclosure. In some embodiments, a system/method can dynamically update an existing TWT schedule established between two devices (e.g., AP and STA, or two STAs) by exchanging a TWT update request frame and a TWT update response frame. Referring to FIG. 5, at step 531, a first device STA #1 501 (e.g., an AP or a non-AP STA) and a second device STA #2 502 (e.g., an AP or a non-AP STA) may establish an initial TWT schedule. At steps 511 and 521, in response to establishing the TWT schedule, each of STA #1 501 and STA #2 502 may monitor changes in (1) traffic between the two devices in a wireless channel and/or (2) applications (e.g., application running on STA #1 501). At step 522, in monitoring changes, STA #2 502 may detect that a degree of a channel congestion metric exceeds (or is greater than) a threshold. The channel congestion metric may include at least one of latency, packet loss, jitter, throughput, network device resource utilization, or channel (or co-channel) interference (which can be calculated/estimated based on noise level or power, signal strength such as RSSI, SNR).

At step 532, in response to detecting channel congestion, STA #2 502 may send a TWT update request frame including one or more desired TWT parameters (e.g., a TWT start time, a TWT SP (wake) interval, an SP (wake) duration), to STA #1 501. At step 533, in response to the TWT update request frame, STA #1 501 may send a TWT update response frame to STA #2 502. In some embodiments, the TWT update response frame may indicate at least one of accepting the request, rejecting the request, or suggesting alternative TWT parameters different from the request. For example, if the TWT update response frame indicates that the request has been accepted, STA #1 501 and STA #2 502 can update the TWT schedule according to the one or more desired TWT parameters specified in the TWT update request frame at step 532.

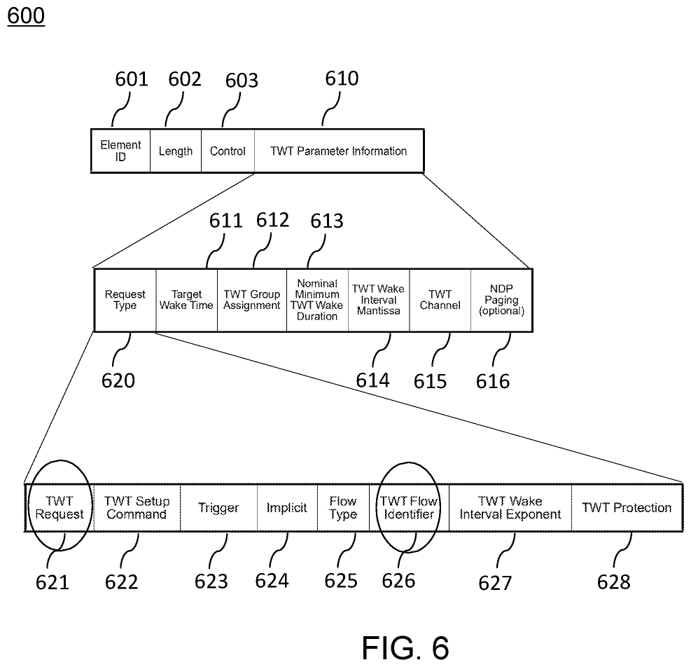

At steps 513 and 523, each of STA #1 501 and STA #2 502 may monitor changes in applications (e.g., application running thereon) or network queues (e.g., transmit queues or receive queues in applications or networking stacks or network interface). At step 514, in monitoring changes, STA #1 501 may detect that a traffic profile, traffic pattern, or network queue (e.g., transmit queue) of one or more applications running on STA #1 501 has been changed. For example, STA #1 may detect that a use-case traffic profile of an application changes (e.g., from x Mbps at y frame per second (fps) to w Mbps at z fps); or that transmit queue depth changes (e.g., increasing queue depth) such that application packets start backing up in the transmit queue beyond tolerance. At step 534, in response to detecting the change of traffic profile, traffic pattern, or network queue, STA #1 501 may send a TWT update request frame including one or more desired TWT parameters (e.g., a TWT start time, a TWT SP (wake) interval, an SP (wake) duration) better suited to the change, to STA #2 502. At step 535, in response to the TWT update request frame, STA #2 502 may send a TWT update response frame to STA #1 501. For example, if the TWT update response frame indicates that the request has been accepted, STA #1 501 and STA #2 502 can update the TWT schedule according to the one or more desired TWT parameters specified in the TWT update request frame at step 534. Various formats of the TWT update request frame and the TWT update response frame will be described in the following sections with reference to FIGS. 6, 7A, 7B, 8A and 8B.

FIG. 6 illustrates example field formats of a TWT information element (also referred to as “TWT element” or “TWT IE”) 600 for updating an existing TWT schedule, according to an example implementation of the present disclosure. In some embodiments, a system/method can update an existing TWT schedule using a TWT information element. For example, a TWT update request frame may include/use/reuse/repurpose the format of a TWT element to indicate a request for an update of an existing TWT schedule, and a TWT update response frame may include/use/reuse/repurpose the format of a TWT element to indicate a response to the request. Referring to FIG. 6, the format of the TWT element 600 may include the fields of element ID 601, length 602, control 603, and/or TWT parameter information 610. The field of TWT parameter information 610 may include the subfields of request type 620, target wake time 611, TWT group assignment 612, nominal minimum TWT wake duration 613, TWT wake interval mantissa 614, TWT channel 615, and/or Non-scheduled Delivery Paging (NDP) paging 616 (optional). The request type 620 subfield may include the subfields of TWT request 621, TWT setup command 622, trigger 623, implicit 624, flow type 625, TWT flow identifier 626, TWT wake interval exponent 627, and/or TWT protection 628.

The TWT request subfield 621 may indicate whether the TWT element 600 represents a (TWT update) request or a (TWT update) response. The size of the TWT request subfield 621 may be two bits. For example, if the TWT request subfield 621 has a value of 0 (“00” when the size of the TWT request subfield is two bits), then the TWT element 600 may represent to initiate or request (from a TWT requesting STA) TWT negotiation/scheduling/setup for a new TWT schedule. If the TWT request subfield 621 has a value of 1 (“01” when the size of the TWT request subfield 621 is two bits), then the TWT element 600 may represent to initiate or request (from a TWT update requesting STA) update of an existing TWT schedule. If the TWT request subfield 621 has a value of 2 or 3 (“10” or “11” when the size of the TWT request subfield is two bits), then the TWT element 600 may represent to respond (from a TWT update responding STA) to a TWT request (e.g., either a request for a new TWT schedule or a request for updating an existing TWT schedule). For example, if the TWT request subfield 621 has a value of “10”, the TWT element may represent/indicate to respond to a request for a new TWT schedule, while if the TWT request subfield 621 has a value of “11”, the TWT element may represent/indicate to respond to a request for updating an existing TWT schedule. The values of the TWT request subfield described above are mere examples and embodiments of the present disclosure are not limited thereto.

The TWT element 600 may contain one or more TWT parameters for one or more TWT negotiations or update negotiations. For example, the one or more TWT parameters may include (1) a TWT start time specified in the target wake time subfield 611, (2) a TWT wake duration or SP duration specified in the subfield of nominal minimum TWT wake duration 613, and/or (3) a TWT wake interval specified in the subfields of TWT wake interval mantissa 614 and/or TWT wake interval exponent 627. Each of the TWT (update) negotiations contained in the TWT element may be identified by a unique TWT flow identifier specified in the subfield of TWT flow identifier 626. For example, in case of TWT schedule update, the TWT flow identifier (ID) corresponding to the already existing TWT agreement may be used in the subfield of TWT flow identifier 626. In some embodiments, the subfield of TWT flow identifier 626 may be set to a TWT flow ID corresponding to any TWT schedule (e.g., either the current TWT schedule or any other TWT schedule) so that a TWT schedule that is not the current TWT schedule can be updated.

Referring to FIGS. 5 and 6, during the process 500 of updating an existing TWT schedule, a STA requesting a TWT STA update (e.g., STA 502) may generate a TWT update request frame including a TWT element (e.g., step 532). The requesting STA may set (1) one or more TWT parameters of the TWT element 600 (e.g., the subfields of target wake time 611, nominal minimum TWT wake duration 613, TWT wake interval mantissa 614 and/or TWT wake interval exponent 627) to values different from those of an existing TWT schedule to reflect a detected channel condition or a detected traffic profile change, (2) the TWT request subfield 621 of the TWT element 600 to a value (e.g., “01”) indicating a request for updating the existing TWT schedule, and/or (3) the TWT flow identifier subfield 626 of the TWT element 600 to a value corresponding to the TWT flow ID of the existing TWT schedule.

During the process 500 of updating the TWT schedule, a STA (e.g., STA 501) responding to the request for the TWT schedule update may generate a TWT update response frame including a TWT element 600 (e.g., step 533). The responding STA may set (1) one or more TWT parameters of the TWT element 600 (e.g., the subfields of target wake time 611, nominal minimum TWT wake duration 613, TWT wake interval mantissa 614 and/or TWT wake interval exponent 627) to values that are the same as, or different from, those specified in the TWT element of the TWT update request frame, (2) the TWT request subfield 621 of the TWT element to a value (e.g., “10” or “11”) indicating a response to the request for updating the existing TWT schedule, and/or (3) the TWT flow identifier subfield 626 of the TWT element to the value corresponding to the TWT flow ID of the existing TWT schedule. If the one or more TWT parameters specified in the TWT update response frame are the same as those specified in the TWT update request frame, the STA responding to the request may confirm the update of TWT parameters to reflect the detected channel congestion or the detected traffic profile change. On the other hand, if the one or more TWT parameters specified in the TWT update response frame are different from those specified in the TWT update request frame, the STA responding to the request may reject the update of TWT parameters and/or indicate or suggest, as alternative TWT parameters, the one or more TWT parameters specified in the TWT update response frame.

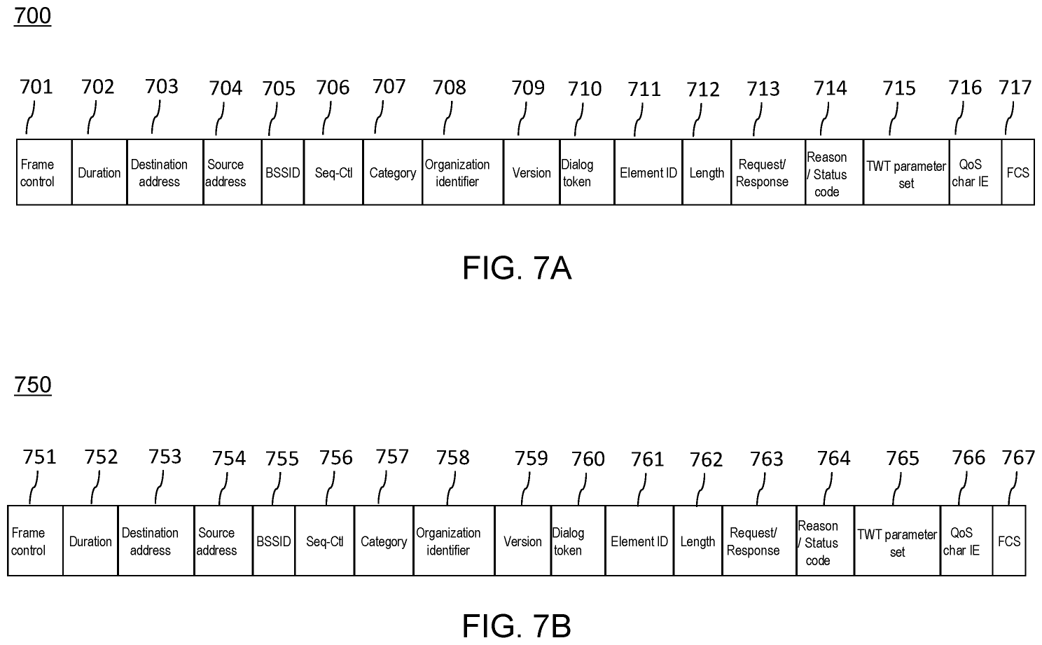

FIG. 7A and FIG. 7B illustrate example field formats of vendor specific action frames 700, 750 for updating a TWT schedule, according to an example implementation of the present disclosure. In some embodiments, a system/method can update an existing TWT schedule using vendor specific action frames (VSAFs). A TWT update request frame may be a VSAF (e.g., VSAF 700) or include/use/reuse/repurpose/leverage the format of a VSAF, to indicate a request for an update of an existing TWT schedule. A TWT update response frame may be a VSAF (e.g., VSAF 750) or can include/use/reuse/repurpose/leverage the format of a VSAF, to indicate a response to a request for an update of an existing TWT schedule.

Referring to FIG. 7A, the format of the VSAF 700 as the TWT update request frame may include a MAC header, a category field 707, and vendor specific content. The MAC header may include the fields of frame control 701, duration 702, destination address 703, source address 704, BSSID 705, and/or sequence control 706. The vendor specific content may include the fields of organization identifier (OUI) 708, version 709, dialog token 710, element ID 711, length 712, request/response 713, reason/status code 714, TWT parameter set 715, QoS characteristic IE 716, and/or FCS 717. The category field 707 may have a value indicating a VSAF. For example, the category field 707 may be set to “0x7E” which indicates a protected VSAF. The OUI field 708 may be a public OUI assigned by the IEEE. The element ID field 711 may have an ID value indicating a TWT update information element (TWT update IE). The length field 712 may indicate a length of the TWT update IE. The TWT parameter set 715 may indicate TWT parameters pertinent to an intended TWT schedule.

Referring to FIG. 7B, the format of a VSAF 750 as the TWT update response frame may include a MAC header, a category field 757, and vendor specific content. The MAC header may include the fields of frame control 751, duration 752, destination address 753, source address 754, BSSID 755, and/or sequence control 756. The vendor specific content may include the fields of OUI 758, version 759, dialog token 760, element ID 761, length 762, request/response 763, reason/status code 764, TWT parameter set 765, QoS characteristic IE 766, and/or FCS 767. The category field 757 may have a value indicating a VSAF. For example, the category field 757 may be set to “0x7E” which indicates a protected VSAF. The OUI field 758 may be a public OUI assigned by the IEEE. The element ID field 761 may have an ID value indicating the TWT update IE. The length field 762 may indicate a length of the TWT update IE. The TWT parameter set 765 may indicate TWT parameters pertinent to an alternative TWT schedule (when the request has been rejected).

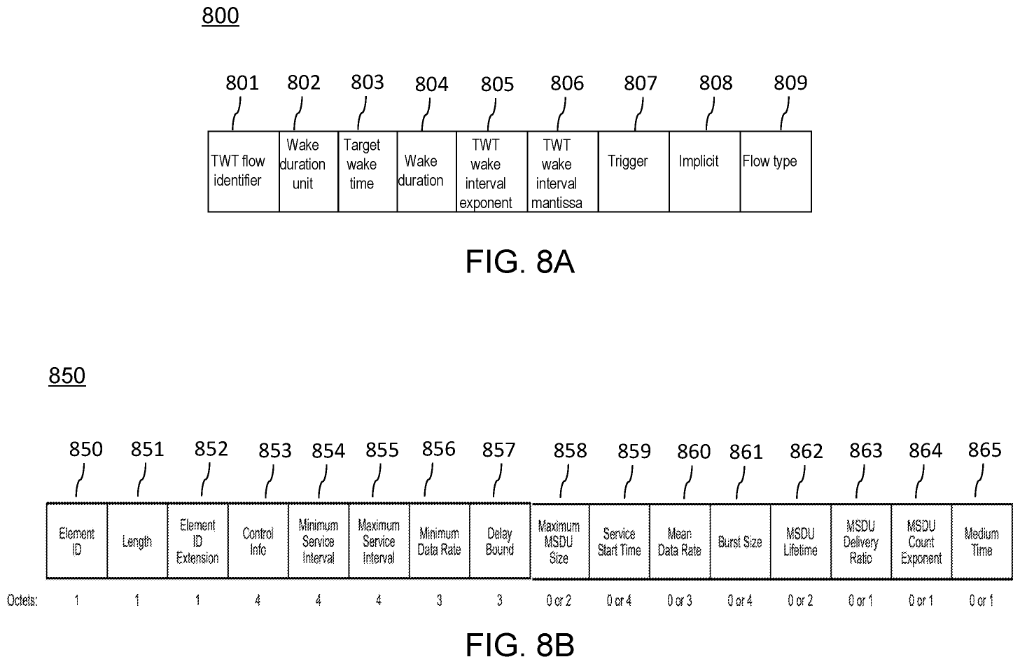

Referring to FIG. 7A and FIG. 7B, the request/response field 713, 763 may indicate whether the VSAF represents a TWT update request frame or a TWT update response frame. The size of the request/response field may be one bit. For example, if the request/response field 713 has a value of 0, then the VSAF 700 may represent to initiate or request (from a TWT update requesting STA) update of an existing TWT schedule. If the request/response field 763 has a value of 1, then the VSAF 750 may represent to respond (from a TWT update responding STA) to a TWT request (e.g., a request for updating an existing TWT schedule). The size of the reason/status code field 714, 764 may be at least one octet (or 8 bits). The reason/status code field 714 in a TWT update request frame (e.g., VSAF 700) may indicate one or more reasons for updating an existing TWT schedule. For example, the reason/status code field 714 in the TWT update request frame may have one or more values selected from a plurality of values including 1 for channel congestion, 2 for application traffic profile change, 3 for increased queue depth, and 4-127 for reserved/unused values. The reason/status code field 763 in a TWT update response frame (e.g., VSAF 750) may indicate one or more statuses for responding to the request for updating an existing TWT schedule. For example, the reason/status code field 764 in the TWT update response frame may have one or more values selected from a plurality of values including 128 for request accepted, 129 for request rejected with suggestion of alternative TWT parameters, 130 for request rejected without suggestion of alternative TWT parameters, and 131-255 for reserved/unused values. The values of the fields of the VSAF described above are mere examples and embodiments of the present disclosure are not limited thereto. The format of TWT parameter set 715, 765 will be described in more detail in the following sections with reference to FIG. 8A. Also, the format of QoS characteristic IE 716, 766 will be described in more detail in the following sections with reference to FIG. 8B.

FIG. 8A and FIG. 8B illustrate example field formats of a TWT parameter set field 800 and a quality of service characteristic information element (referred to as “QoS Characteristic IE”) 850 for updating a TWT schedule, according to an example implementation of the present disclosure. In some embodiments, the TWT parameter set field may contain one or more TWT parameters (e.g., TWT start time, TWT wake duration, TWT wake interval) for one or more TWT negotiations or update negotiations. Referring to FIG. 8A, the TWT parameter set field 800 may include the subfields of TWT flow identifier 801, wake duration unit 802, target wake time 803, wake duration 804, TWT wake interval exponent 805, TWT wake interval mantissa 806, trigger 807, implicit 808, and/or flow type 809. Each of the TWT (update) negotiations contained in the VSAF (e.g., VSAF 700, 750) may be identified by a unique TWT flow identifier specified in the subfield of TWT flow identifier 801. For example, in case of TWT schedule update, the TWT flow identifier (ID) corresponding to the already existing TWT schedule or agreement may be used in the subfield of TWT flow identifier. In some embodiments, the subfield of TWT flow identifier 801 may be set to a TWT flow ID corresponding to any TWT schedule (e.g., either the current TWT schedule or any other TWT schedule) so that a TWT schedule that is not the current TWT schedule can be updated. The target wake time subfield 803 may represent a TWT start time specified. The subfields of wake duration 804 and wake duration unit (e.g., ms or μs) 802 may represent/indicate/specify a TWT wake duration or SP duration. The subfields of TWT wake interval exponent 805 and TWT wake interval mantissa 806 may represent/specify/indicate a TWT wake interval.

Referring to FIG. 8B, the QoS characteristic IE 850 may include the subfields of element ID 850, length 851, element ID extension 852, control info 853, minimum service interval 854, maximum service interval 855, minimum data rate 856, delay bound 857, maximum MSDU size 858, service start time 859, mean data rate 860, burst size 861, MSDU lifetime 862, MSDU delivery ratio 863, MSDU count exponent 864, and/or medium time 865. In some embodiments, a request VSAF (e.g., VSAF 700) may optionally include the QoS characteristic IE 850 set to QoS characteristic values corresponding to a new traffic profile if the reason/status code (e.g., the reason/status code subfield 714) is set to indicate a traffic profile change (e.g., value 2). In some embodiments, a response VSAF (e.g., VSAF 750) may optionally include the QoS characteristic IE 850.

Referring to FIGS. 5, 7A, 7B, 8A and 8B, during the process 500 of updating an existing TWT schedule, a STA requesting a TWT STA update (e.g., STA 502) may generate a TWT update request frame which may be or include a VSAF 700 (e.g., at step 532). The requesting STA 502 may set (1) the request/response subfield 713 of the VSAF 700 to a value (e.g., 0) indicating a request for updating the existing TWT schedule, (2) the reason/status code field 714 of the VSAF 700 to one or more values selected from a plurality of values indicating reasons for updating the existing TWT schedule (e.g., value 1 for channel congestion, value 2 for application traffic profile change, value 3 for increased queue depth), (3) the TWT parameter set field 715 of the VSAF 700 (e.g., the subfields of wake duration unit 802, target wake time 803, wake duration 804, TWT wake interval exponent 805, TWT wake interval mantissa 806) to values different from one or more TWT parameters of the existing TWT schedule to reflect reasons specified in the reason/status code field, and/or (4) the TWT flow identifier subfield 801 of the VSAF 700 to a value corresponding to the TWT flow ID of the existing TWT schedule or agreement. In some embodiments, the subfield of TWT flow identifier 801 may be set to a TWT flow ID corresponding to any TWT schedule (e.g., either the current TWT schedule or TWT schedule) so that a TWT schedule that is not the current TWT schedule can be updated.

In some embodiments, during the process 500 of updating the TWT schedule, a STA (e.g., STA 501) responding to the request for the TWT schedule update may generate a TWT update response frame (e.g., at step 533) which may be or include a VSAF 750. The responding STA may set (1) the request/response subfield 763 of the VSAF 750 to a value (e.g., 1) indicating a response to a request for updating the existing TWT schedule, (2) the reason/status code field 764 of the VSAF 750 to one or more values selected from a plurality of values indicating statuses in response to the request (e.g., value 128 for request accepted, value 129 for request rejected with suggestion of alternative TWT parameters, value 130 for request rejected without suggestion of alternative TWT parameters), (3) the TWT parameter set field 765 of the VSAF 750 (e.g., the subfields of wake duration unit 802, target wake time 803, wake duration 804, TWT wake interval exponent 805, TWT wake interval mantissa 806) to values corresponding to alternative TWT parameters (e.g., if the reasons/status code field 764 is set to value 129 indicating “request rejected with suggestion of alternative TWT parameters”), and/or (4) the TWT flow identifier subfield 801 of the VSAF 750 to a value corresponding to the TWT flow ID of the existing TWT schedule or agreement. In some embodiments, the subfield of TWT flow identifier 801 may be set to a TWT flow ID corresponding to any TWT schedule (e.g., either the current TWT schedule or TWT schedule) so that a TWT schedule that is not the current TWT schedule can be updated.

In some embodiments, during the process 500 of updating an existing TWT schedule between STA #1 501 (e.g., an AP or a non-AP STA) and STA #2 502 (e.g., an AP or a non-AP STA), a requesting STA (e.g., STA #1 501) may issue/send a TWT update request frame (e.g., at step 534) which is or includes a VSAF 700, to a recipient STA (e.g., STA #2 502) informing STA #2 502 about not only one or more requested TWT parameters (e.g., using the TWT parameter set field 715) but also a need/intent/reason/motivation to update the existing TWT schedule (e.g., using the reason/status code field 714). The request VSAF 700 may include the reason/status code subfield 714 to indicate the need/intent/reason/motivation to change the existing TWT schedule and may include the TWT parameter set field 715 set to a preferred TWT schedule (e.g., TWT parameters of preferred TWT schedule) as well. STA #2 502 may receive the request VSAF 700 and assess/evaluate/determine whether a change is warranted. Based on the evaluation, STA #2 502 may respond back with a response VSAF 750 (e.g., at step 535) to STA #1 501 indicating whether the change has been accepted, rejected, or rejected with a proposed alternative change (e.g., using the TWTW parameter set field 765).

In some embodiments, during the process 500 of updating an existing TWT schedule, after STA #1 and STA #2 establish an initial TWT schedule at step 531, STA #1 may receive a TWT update request frame from STA #2. The TWT update request frame may be a VSAF 700 having the format shown in FIG. 7A. The request VSAF frame 700 may include (1) the request/response field 713 set to indicate a “request” (e.g., value 0), (2) the reason/status code field 714 set to indicate channel congestion (e.g., value 0x1), and (3) the TWT parameter set field 715 set to TWT parameters of a new (requested) TWT schedule to reflect the channel congestion. In response to the TWT update request frame, STA #1 may send a TWT update response frame to STA #2 at step 532. The TWT update response frame may be a VSAF 750 having the format shown in FIG. 7B. The response VSAF frame 750 may include (1) the request/response field 763 set to indicate a “response” (e.g., value 1), (2) the reason/status code field 764 set to an appropriate status code (e.g., value 128 to indicate the request has been accepted, value 129 to indicate the request has been rejected with suggestion of alternative TWT parameters, or value 130 to indicate the request has been rejected without suggestion), and/or (3) the TWT parameter set field 765 set to alternative/proposed TWT parameters (e.g., when the reason/status code field 764 set to value 129 to indicate the request has been rejected, with suggestion of alternative TWT parameters).

In some embodiments, during the process 500 of updating an existing TWT schedule, as a result of monitoring channel congestion or application traffic profile patterns at step 513, 523, STA #1 may send a TWT update request frame to STA #2 at step 534. The TWT update request frame may be a VSAF 700 having the format shown in FIG. 7A. The request VSAF frame 700 may include (1) the request/response field 713 set to indicate a “request” (e.g., value 0), (2) the reason/status code field 714 set to indicate a traffic profile change (e.g., value 0x2), (3) the TWT parameter set field 715 set to TWT parameters of a new TWT schedule to reflect the traffic profile change, and/or (4) the QoS characteristic IE 716 set to QoS characteristic values corresponding to a new traffic profile (due to the traffic profile change). In response to the TWT update request frame, STA #2 may send a TWT update response frame (e.g., at step 535) which may be a VSAF 750 having the format shown in FIG. 7B. The response VSAF frame 750 may include (1) the request/response field 763 set to indicate a “response” (e.g., value 1), (2) the reason/status code field 764 set to an appropriate status code/value (e.g., “the request accepted”, “the request rejected with suggestion of alternative TWT parameters”, or “the request rejected without suggestion), and/or (3) the TWT parameter set field 765 set to alternative/proposed TWT parameters (e.g., when the reason/status code field 764 set to value 129 to indicate the request has been rejected with suggestion of alternative TWT parameters).

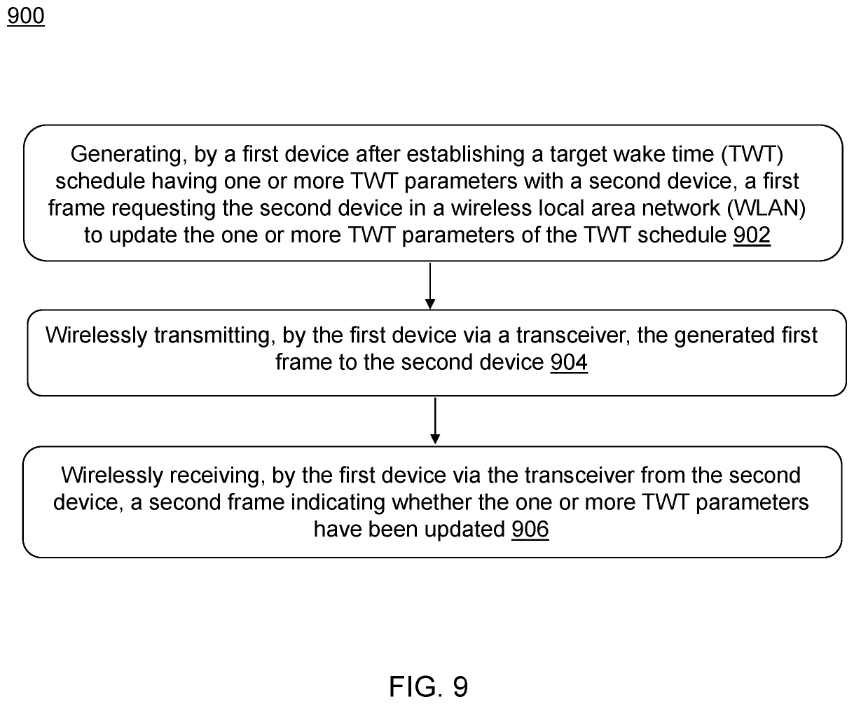

FIG. 9 is a flowchart showing a method for updating a TWT schedule, according to an example implementation of the present disclosure. In some embodiments, the process 900 is performed by a first device (e.g., console 120, HWD 150, computer system 314, STA #1 501, STA #2 502). In some embodiments, the process 900 is performed by other entities. In some embodiments, the process 900 includes more, fewer, or different steps than shown in FIG. 9.

In one approach, the first device (e.g., STA #1) may generate 902, after establishing a target wake time (TWT) schedule having one or more TWT parameters with a second device (e.g., after STA #1 establishes a TWT schedule with STA #2 at step 531), a first frame (e.g., TWT update request frame) requesting the second device in a wireless local area network (WLAN) to update the one or more TWT parameters of the TWT schedule. In some embodiments, one of the first device or the second device may be an access point. In some embodiments, the one or more TWT parameters may include at least one of a target wake time, a wake duration, or a wake interval.

In some embodiments, the first device (e.g., STA #1) may set a first subfield of the first frame (e.g., TWT flow identifier subfield 626, TWT flow identifier subfield 801) to an identifier identifying the TWT schedule. the first device (e.g., STA #1) may set a second subfield of the first frame (e.g., TWT request subfield 621, request/response subfield 713) to a value indicating a request for updating the TWT schedule. One or more subfields of the first frame (e.g., TWT parameter information field 610, TWT parameter set field 715) may be set to a first set of one or more TWT parameters (e.g., desired/requested TWT parameters) that are different from the one or more TWT parameters of the TWT schedule (e.g., different from TWT parameters of the existing TWT schedule).

In one approach, the first device (e.g., STA #1) wirelessly transmit 904, via a transceiver, the generated first frame (e.g., TWT update request frame) to the second device (e.g., STA #2). For example, referring to FIG. 5, STA #1 wirelessly transmits a TWT update request frame to STA #2 at step 534. In one approach, the first device (e.g., STA #1) wirelessly receive 906, via the transceiver from the second device (e.g., STA #1), a second frame (e.g., TWT update response frame) indicating whether the one or more TWT parameters have been updated. For example, referring to FIG. 5, STA #1 wirelessly receives a TWT update response frame from STA #2 at step 535. The second frame may include a first subfield (e.g., TWT flow identifier subfield 626, TWT flow identifier subfield 801) having the identifier identifying the TWT schedule (e.g., the existing TWT schedule), a second subfield (e.g., TWT request subfield 621, request/response subfield 763) having a value indicating a response to the request for updating the TWT schedule, and one or more subfields (e.g., TWT parameter information field 610, TWT parameter set field 765) having a second set of one or more TWT parameters.

In some embodiments, the first set of one or more TWT parameters may be compared with the second set of one or more TWT parameters. For example, if each of the TWT update request frame and the TWT update response frame includes a TWT element 600, the first device may compare values of the TWT parameters of the TWT update request frame (e.g., the subfields of target wake time 611, nominal minimum TWT wake duration 613, TWT wake interval mantissa 614, TWT wake interval exponent 627) with values of the TWT parameters of the TWT update response frame (e.g., the subfields of target wake time 611, nominal minimum TWT wake duration 613, TWT wake interval mantissa 614, TWT wake interval exponent 627). According to a result of the comparing, it may be determined whether the one or more TWT parameters have been updated. For example, if the one or more TWT parameters specified in the TWT update response frame are the same as those specified in the TWT update request frame, the STA responding to the request (e.g., STA #2) may confirm the update of TWT parameters to reflect the detected channel congestion or the detected traffic profile change. On the other hand, if the one or more TWT parameters specified in the TWT update response frame are different from those specified in the TWT update request frame, the STA responding to the request (e.g., STA #2) may reject the update of TWT parameters and/or indicate or suggest, as alternative TWT parameters, the one or more TWT parameters specified in the TWT update response frame.

In some embodiments, the first frame (e.g., TWT update request frame) may include a TWT information element (e.g., TWT IE or TWT element 600). The TWT IE 600 may include the first subfield (e.g., TWT flow identifier subfield 626), the second subfield (e.g., TWT request subfield 621) and the one or more subfields of the first frame (e.g., the subfields of target wake time 611, nominal minimum TWT wake duration 613, TWT wake interval mantissa 614, TWT wake interval exponent 627).

In some embodiments, the first frame may be a vendor specific action frame (e.g., VSAF 700). A third subfield of the first frame (e.g., reason/status code subfield 714) may be to a value indicating a reason for updating the TWT schedule, wherein the reason includes one of (1) a change in channel congestion (e.g., indicated by value 1), (2) a change in application traffic profile (e.g., indicated by value 2), or (3) an increase in queue depth (e.g., indicated by value 3). The vendor specific action frame (e.g., VSAF 700) may include a quality of service characteristics information element (e.g., QoS characteristics IE 715, 850). Responsive to setting the third subfield (e.g., reason/status code subfield 714) to a value indicating (2) a change in application traffic profile (e.g., value 2), the QoS characteristics IE (e.g., QoS characteristics IE 715, 850) may be set to one or more values indicating a new application traffic profile. The second frame may be a vendor specific action frame (e.g., VSAF 750). The second frame may include a subfield (e.g., reason/status code subfield 764) having a value indicating a status of responding to the request for updating the TWT schedule. The status may be one of (1) request accepted (e.g., indicated by value 128), (2) request rejected with indication of alternative TWT parameters (e.g., indicated by value 129), or (3) request rejected without indication of alternative TWT parameters (e.g., indicated by value 130).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
generate, after establishing a target wake time (TWT) schedule having one or more TWT parameters with a second device, a first frame requesting the second device in a wireless local area network (WLAN) to update the one or more TWT parameters of the TWT schedule;
wirelessly transmit, via a transceiver, the generated first frame to the second device; and
wirelessly receive, via the transceiver from the second device, a second frame indicating whether the one or more TWT parameters have been updated.

2. The first device according to claim 1, wherein one of the first device or the second device is an access point.

3. The first device according to claim 1, wherein the one or more TWT parameters include at least one of a target wake time, a wake duration, or a wake interval.

4. The first device according to claim 1, wherein the one or more processors are configured to:
set a first subfield of the first frame to an identifier identifying the TWT schedule,
set a second subfield of the first frame to a value indicating a request for updating the TWT schedule, and
set one or more subfields of the first frame to a first set of one or more TWT parameters that are different from the one or more TWT parameters of the TWT schedule.

5. The first device according to claim 4, wherein the second frame comprises:
a first subfield having the identifier identifying the TWT schedule,
a second subfield having a value indicating a response to the request for updating the TWT schedule, and
one or more subfields having a second set of one or more TWT parameters.

6. The first device according to claim 5, wherein the one or more processors are configured to:
compare the first set of one or more TWT parameters with the second set of one or more TWT parameters, and
determine, according to a result of the comparing, whether the one or more TWT parameters have been updated.

7. The first device according to claim 4, wherein:
the first frame includes a TWT information element (TWT IE), and
the TWT IE includes the first subfield, the second subfield and the one or more subfields of the first frame.

8. The first device according to claim 4, wherein:
the first frame is a vendor specific action frame, and
the one or more processors are configured to:
set a third subfield of the first frame to a value indicating a reason for updating the TWT schedule, wherein the reason includes one of (1) a change in channel congestion, (2) a change in application traffic profile, or (3) an increase in queue depth.

9. The first device according to claim 8, wherein:
the vendor specific action frame comprises a quality of service characteristics information element (QOS characteristics IE), and
responsive to setting the third subfield to a value indicating (2) a change in application traffic profile, the one or more processors are configured to:
set the QoS characteristics IE to one or more values indicating a new application traffic profile.

10. The first device according to claim 7, wherein:
the second frame is a vendor specific action frame, and
the second frame comprises:
a subfield having a value indicating a status of responding to the request for updating the TWT schedule, wherein the status is one of (1) request accepted, (2) request rejected with indication of alternative TWT parameters, or (3) request rejected without indication of alternative TWT parameters.

11. A method comprising:
generating, by a first device after establishing a target wake time (TWT) schedule having one or more TWT parameters with a second device, a first frame requesting the second device in a wireless local area network (WLAN) to update the one or more TWT parameters of the TWT schedule;
wirelessly transmitting, by the first device via a transceiver, the generated first frame to the second device; and
wirelessly receiving, by the first device via the transceiver from the second device, a second frame indicating whether the one or more TWT parameters have been updated.

12. The method according to claim 11, wherein one of the first device or the second device is an access point.

13. The method according to claim 11, wherein the one or more TWT parameters include at least one of a target wake time, a wake duration, or a wake interval.

14. The method according to claim 11, further comprising:
setting a first subfield of the first frame to an identifier identifying the TWT schedule,
setting a second subfield of the first frame to a value indicating a request for updating the TWT schedule, and
setting one or more subfields of the first frame to a first set of one or more TWT parameters that are different from the one or more TWT parameters of the TWT schedule.

15. The method according to claim 14, wherein the second frame comprises:
a first subfield having the identifier identifying the TWT schedule,
a second subfield having a value indicating a response to the request for updating the TWT schedule, and
one or more subfields having a second set of one or more TWT parameters.

16. The method according to claim 15, further comprising:
comparing the first set of one or more TWT parameters with the second set of one or more TWT parameters, and
determining, according to a result of the comparing, whether the one or more TWT parameters have been updated.

17. The method according to claim 14, wherein:
the first frame includes a TWT information element (TWT IE), and
the TWT IE includes the first subfield, the second subfield and the one or more subfields of the first frame.

18. The method according to claim 14, wherein:
the first frame is a vendor specific action frame, and
the method comprises:
setting a third subfield of the first frame to a value indicating a reason for updating the TWT schedule, wherein the reason includes one of (1) a change in channel congestion, (2) a change in application traffic profile, or (3) an increase in queue depth.

19. The method according to claim 18, wherein:
the vendor specific action frame comprises a quality of service characteristics information element (QOS characteristics IE), and
the method comprises:
responsive to setting the third subfield to a value indicating (2) a change in application traffic profile, setting the QoS characteristics IE to one or more values indicating a new application traffic profile.

20. The method according to claim 18, wherein:
the second frame is a vendor specific action frame, and
the second frame comprises:
a subfield having a value indicating a status of responding to the request for updating the TWT schedule, wherein the status is one of (1) request accepted, (2) request rejected with indication of alternative TWT parameters, or (3) request rejected without indication of alternative TWT parameters.
